(19) United States
(12) Patent Application Publication
(10) Pub. No.: US 2013/0101711 A1
(43) Pub. Date: Apr. 25, 2013

(54) Coated Pet Chew and Method of Making

(71) Applicant: SERGEANT'S PET CARE PRODUCTS, INC., Omaha, NE (US)

(72) Inventor: Mark Levin, Papillion, NE (US)

(73) Assignee: SERGEANT'S PET CARE PRODUCTS, INC., Omaha, NE (US)

(21) Appl. No.: 13/693,716

(22) Filed: Dec. 4, 2012

Related U.S. Application Data
(62) Division of application No. 12/394,314, filed on Feb. 27, 2009.

(51) Int. Cl. A23K 1/00

(52) U.S. Cl. CPC A23K 1/004
USPC 426/304; 426/307

(57) ABSTRACT

Disclosed is a coated pet chew and a method of making. The coated pet chew comprises a substrate coated with unrefined collagen.

### CROSS-REFERENCE TO RELATED APPLICATION

This application is a divisional application of application Ser. No. 12/394,314 filed Feb. 27, 2009, which claims priority to Provisional Application Ser. No. 61/089,947 filed on Aug. 19, 2008, both of which are hereby incorporated by reference in their entireties.

### FIELD OF THE INVENTION

The present invention relates to a coated pet chew and a method for making. In particular, the coated pet chew is formed when unrefined collagen is applied to the chew as a coating.

### BACKGROUND OF INVENTION

For some time now, pet chews have been widely available, with the pet chew being a product that the animal may consume. A variety of pet chews are commercially available ranging from food-like products to synthetic materials. Pet chews are often used to aid in maintenance of the animal's teeth and gums. Hard chews are often used to clean an animal's teeth due to the friction exerted on the tooth when the animal bites down on the chew; however, soft chews are also used to clean an animal's teeth. Chews can also be given to a pet to help relieve stress. As such, hard and soft chews are used to occupy an animal's attention, as the animal enjoys gnawing on the chew.

A wide range of materials can be utilized to make pet chews. Depending on the material of the chew, different chews can have varying degrees of hardness and elasticity. Chews formed from rawhide and similar substances are well known in the art. Rawhide can be folded and dried into various shapes such as bones, knots, etc. Usually the rawhide has to be wet or moist when forming the shape. Once the rawhide is formed to shape, it is dried on a bakery rack in a drying room, where the moisture is removed. This process can take up to 5 days as this is the amount of time sufficient to remove the free water to a point that bacteria growth is minimized.

Chews formed from material other than rawhide, including pig ears or ligaments, are dried until they are hard and suitable for chewing and consumption. Application of a baste coating has been used to create a chew with a more appealing color and flavor. These bastings have also been applied to rawhide to create a more natural looking chew.

Additionally, a variety of nutraceuticals have been used as additives to make chews more appealing to pet owners by providing additional nutritional benefits to the structure of the chew. These nutraceuticals are added to the composition in a variety of ways. Beneficially, the nutraceutical provides an added benefit beyond that derived from merely chewing on the material.

Collagen is a long fibrous structural protein that accounts for a major component of the extracellular matrix. The structure of collagen is a triple helix and in this state it is referred to as tropocollagen. When collagen is partially hydrolyzed, its triple helix structure separates into globular, random coils, which can produce gelatin. Gelatin is a more purified form of collagen that is sensitive to temperature variations and time. Gelatin goes through an ultra filtration process wherein most of the fat content and other impurities are removed from the collagen. In pure form, gelatin is odorless and flavorless. Gelatin produces a semi-solid composition when mixed with water and therefore is widely used as a cooking agent and is contained in gelatin desserts, jelly, marshmallows, and gummy bears.

Collagen has also been used as a basis for animal glues. Hide glue, made from collagen extracted from hides, is one of the oldest forms of glue. Most hide glues are made using cowhide scraps too small or oddly shaped to be used as leather, however, some of the higher quality hide glues are made from rabbit hide. Bone glue is another type of animal glue produced from collagen extracted from crushed or shredded bone. This type of glue tends to be more acidic than hide glue making it subordinate to the quality of hide glue. Gelatin can also be used as animal hide glue, with the difference being that the gelatin is highly purified and processed with greater care to avoid contaminants. Gelatin is graded according to its purity making some forms suitable for eating, while other forms are suitable for adhesives.

### SUMMARY OF THE INVENTION

The present invention is directed towards a pet chew composition comprising a substrate which is coated with unrefined collagen, which is collagen that has been heated but not refined, meaning that animal bi-products, such as fatty acids, are still present in the unrefined collagen. The invention also relates to a method of using unrefined collagen and a method for coating a rawhide. A coated pet chew, in accordance with the present invention, provides several advantages over the prior art including an improved shelf life, extended length of chew time, ease of manufacturing, and overall appeal to animals. The coating provides a hard covering which is generally air tight, meaning that the very little air penetrates the coating to reach the inner substrate. This coating results in improved shelf life, by reducing oxidation, rancidity and moisture pickup, preventing or greatly reducing the incidence of issues arising with materials normally used for animal chews. For example, a rawhide chew made in accordance with the present invention will be less likely to be exposed to moisture, which can cause a build up of bacteria and mold. Additionally, the coated chew disclosed herein is also more appealing to pets given the higher fat content and naturally meaty aroma of its coating.

The coating provides a unique aesthetic in that the unrefined collagen produces a transparent clear coating, a transparent colored coating, or an opaque colored coating. The coatings produce a covering that appears as a glossy lacquer emphasizing the brilliance of the color in the colored coatings and accentuating the natural appearance of the rawhide in the clear coating. This glossy finish is visually unique and especially attractive to pets and their owners, as it gives the pet chew the appearance of hard candy or other types of sugared confections. Other flavors and colors can also be added to the collagen to change the taste and appearance of the rawhide chew. Unlike previously available chews where the chew is immersed in the flavoring and the flavoring is absorbed into the chew, the flavorings used in the present invention are added to the coating. The coating is distinct from the use of a gelatin coating in that the coating used in the present invention has enhanced binding ability to the chew, is easily pourable, and provides an even coating that remains clear, meaning that air bubble do not get trapped in the coating giving it a cloudy appearance. Gelatin and other forms of refined collagen will not work with the methods of the present invention as the solution may burn. The thickness of the coating can be increased to improve chew time and visual aesthetics. The coated chew is equally appealing to a pet owner, as the longevity of chew time occupies the animal's attention thereby making an animal less likely to chew on household items such as couches, remote controls, shoes, etc. Additionally, the coating is likely aesthetically appealing to the owners because of its unique and attractive appearance.

### DETAILED DESCRIPTION

The present invention relates to a coated pet chew formed from a substrate coated in unrefined collagen and a method of making. The method includes melting the unrefined collagen and dipping the substrate into the melted unrefined collagen.

The substrate can be composed of any material suitable for chewing by a pet. Examples of preferred substrates include, but are not limited to, rawhide, biscuits, chewy treats, dried animal parts, such as a pig ear, as well as other materials known in the art to be suitable and intended for chewing by a pet. The chew according to the present invention can vary in size and shape, but is preferred to be a size and shape appropriate for the size and type of pet for which the chew is intended. In a most preferred embodiment, the substrate is a type of pet chew. For example: rawhide can be a stick, bone, knot, or other shape; a biscuit can be a bone, cookie, stick or other shape.

The coating for the chew is comprised of unrefined collagen. Unrefined collagen has the characteristic of containing the indigenous oils from the animal hides along with the minerals and salts typically found in animal hides, bones, and bi-products. Collagen from such sources typically has at least 0.25% to about 4% of the indigenous oils, salts and minerals by volume of the unrefined collagen. Indigenous oils, salts and minerals are normally not present at this level in other types of refined collagen. Preferably the unrefined collagen contains about 0.5% to about 3% indigenous oils and mineral salt by volume of the unrefined collagen. Moisture content in the unrefined collagen is about 20%-50%. In a preferred embodiment, the unrefined collagen has a melting point of about 100° F. to about 140° F., more preferably about 100° F. to about 120° F., and even more preferably about 100° F. to about 120° F. The collagen used in the present invention is not heated at a temperature greater than 160° F. to prevent hydrolysis. Hydrolysis at a temperature of 160° F. or higher causes a breakdown of the internal helical structure of the collagen and denaturing. The unrefined collagen coating, after the coated substrate is cured or dried, results in a hard coating which has a higher fat and mineral salt content and a more pleasing flavor to pets than its more refined collagen counterparts would have, making it especially palatable to pets.

Forms of refined collagen, such a gelatin, are not suitable as a coating material in accordance with the present invention. Refined collagen or gelatin, when used as a coating, has several disadvantages. The refined collagen or gelatin allows moisture to be absorbed into the substrate, leading to the potential for bacterial growth; does not easily adhere to the substrate, producing an inconsistent covering; and requires a longer drying period than coatings made of unrefined collagen. Additionally, unrefined collagen contains higher levels of chondrin, the adhesive or binding protein in collagen, as opposed to gluten, the gelling protein in collagen on which gelatins rely. Chondrin allows the unrefined collagen to more easily adhere to the substrate. The coating has the added benefit of being easily pourable as well as producing a clear coating for the pet chew, in the absence of added colorings. An example of a suitable unrefined collagen material is PROBOND 1560. PROBOND 1560 is produced by International Protein Colloids, Inc. The substrate can be coated once or multiple times to achieve a desired coating thickness.

A preferred embodiment includes using the unrefined collagen to achieve a rich clear coating. Another preferred embodiment includes adding a colorant to the coating wherein differing numbers of coatings are preferred to achieve particular color intensity. This embodiment includes the steps of taking unrefined collagen; melting the unrefined collagen at a temperature of about 100° F. to about 140° F.; adding a colorant and mixing; dipping a substrate into the melted unrefined collagen and colorant mixture; and laying the coated substrate on a piece of waxed paper or a rack to cool and dry. This process results in a substrate that has a colored coating. Depending on the colorant used, a transparent colored coating or opaque colored coating can be produced. Preferably the substrate is coated once, more preferably the substrate is coated twice, and more preferably the substrate is coated three times or more. In a preferred embodiment, one coat produces a single coating, which has a thickness of between about 0.1 mm and 0.8 mm, and two coats produces a double coating, which has a thickness of between about 0.60 mm and 3.0 mm. The thickness of each coating layer is influenced by: the temperature of the melted unrefined collagen; residence time in the dip; and, the temperature of the substrate being dipped. Additionally, thickeners can be added to the unrefined collagen to increase the viscosity of the melted unrefined collagen to increase the thickness of coatings. Thickeners such as pre-gelatinized starch, food gums, and other colloids can be used.

In an additionally preferred embodiment, the coating of the pet chew may contain colorings. The colorings can be added to create a transparent colored coating or an opaque colored coating. In the absence of added colorings, the coating is a transparent clear coating. Preferably, these colors are selected from colors which include FD&C dyes, aluminum lake colors, natural pigments, and titanium dioxide. As such, a clear coat can be used, a color coat, or a color with a clear coat.

The pet chew of the present invention is already rich in amino acids and collagen but may contain one or more additives in combination with the coating to provide nutrients or alternative flavors to the animal. Preferably these additives are selected from flavors, palatants, nutrients and/or sources of nutrients, including brewers yeast, D-Biotin, flax seed, polyunsaturated fatty acids, Vitamin E, Vitamin B, Vitamin B6, Vitamin A, Vitamin D, Panthothenic Acid, and combinations thereof. Preferably, one or more additives are admixed with the coating in a concentration of about 0.005%-15% depending on the nutraceutical used.

In an additionally preferred embodiment, the substrate is coated in a combination of unrefined collagen and glycerin. Preferably, the glycerin is present in the coating at about 0.5%-6% by weight of the coating, more preferably at about 1%-5% by weight, more preferably at about 2%-4% by weight, and most preferably at about 2% by weight of the total coating. This coating has the additional benefit of not showing cracking when exposed to dry environments where humidity is low.

A method for making a coated pet chew is also disclosed. This process generally includes combining an amount of unrefined collagen with one or more additives, as described herein. The composition is then heated and melted in a heated vessel, such as a stainless steel pot placed on a heat source, preferably to a temperature of around 100°-140° F. The melted composition is used to coat a desirable substrate by dipping or enrobing the substrate with the melted unrefined collagen coating, resulting in the substrate being evenly coated. Once the substrate has been coated, it is placed on a cooling rack to cool for between 5 to 60 minutes, allowing the coating to cool and set.

The coated substrate is then dried and cured for between 8 to 12 hours at a temperature of about 72° F. to about 90° F. to ensure that the moisture is removed and the water activity reduced to less than 0.65. This process results in a substrate with a hard coating. The viscosity of the melted collagen coating is most favorably between 500 and 8000 cps (centipoises). Preferably, the substrate being coated is already formed and dried prior to coating or is at least shelf stable. The substrate can be coated multiple times to achieve a thicker coating or more pleasing color.

Thus, there has been described a coated pet chew and a method for making a coated pet chew having an extended chew life due to the pet chew being coated with at least a single coat of unrefined collagen, as well as an appearance that is visually, aromatically, and nutritionally appealing to dogs, and a flavor that dogs prefer since the unrefined collagen naturally contains a higher fat and mineral salt content. It is apparent to those skilled in the art, however, that many changes, variations, modifications, other uses, and applications to the coated pet chew and method of making the coated pet chew are possible, and also such changes, variations, modifications, other uses, and applications which do not depart from the spirit and scope of the invention are deemed to be covered by the invention, which is limited only by the claims which follow.

### DEFINITIONS

“Air tight”, as used herein, is meant to encompass a state wherein very little outside air can reach the inner substrate when coated.

A “pet chew”, as used herein, refers to any material suitable for consumption by an animal, including pet treats, pet snacks, and the like.

A “rawhide,” for purposes of the present invention, refers to a hide or animal skin that has not been exposed to tanning but has been processed in a typical manner for rawhide pet chews. It is a hard material which can be rewetted and formed and allowed to thoroughly dry. It is commonly used as a chew toy for dogs and other animals.

A “single coating” of unrefined collagen means that the substrate was only coated one time, while a “double coating” of unrefined collagen means that the substrate was coated a second time, making a “double coating” of unrefined collagen thicker than a “single coating” of the same material.

“Unrefined collagen”, as used herein, refers to collagen that contains the natural fats and oils and other materials found in the bones, cartilage, and animal hides used to harvest the collagen, and which the collagen has not been purified or refined. This more natural form of collagen that has not been purified, bleached, or deodorized, leads to the “unrefined” collagen containing a higher percentage of condrin and fat, as well as having a meatier smell and flavor. Additionally, the “unrefined collagen” of the present invention has not been hydrolyzed to a temperature greater than 160° F. Additionally, unrefined collagen is not considered gelatin by those of skill in the art. Collagen considered “unrefined” is in a more natural, raw state and is less purified than gelatin or other forms of refined collagen and melts at a temperature of about 100° F. to about 140° F. at a moisture content of 50%.

### EXAMPLES

The following examples are for illustrative purposes only and are not to be construed as limiting the scope of the subject invention.

### Example 1

This example provides one method of making the coated chew of the present invention.

1305 g of PROBOND-1560 (produced by International Protein Colloids, Inc.) was added to 19.6 g of SB264 palatability enhancer from AFB. This combination was then heated to 140° F. 50 sticks of rawhide in varying flavors were then dipped into the collagen substance and laid to dry. This process was repeated twice so that the rawhide sticks had two coats of unrefined collagen. The coated rawhide sticks were then cured at room temperature for 8-12 hours to remove water and harden.

This process produced a treat with a hard covering which appeared to keep air from reaching the inner rawhide stick. The dried colloid coated rawhide was highly palatable by dogs and surprisingly lasted longer for dogs to consume. The rawhide stick weighed 37.1 g before dipping and weighed 46.0 g with two coatings. The thickness of the single coating was 0.15 mm-0.45 mm and the thickness of the double coating was 0.89-2.5 mm.

### Example 2

436.4 g of gelatin, which is distinct from unrefined collagen, was added to 187.0 g of water and mixed. The water was quickly absorbed by some, but did not hydrate the entire amount of gelatin. Upon heating, the hydrated gelatin melted but the unhydrated gelatin did not and began to scorch and burn.

Gelatin is a refined form of collagen which does not include the bi-products present in unrefined collagen, such as fatty acids. The moisture in the gelatin was absorbed by the inner rawhide providing the potential for bacteria to grow. Additionally, the unhydrated gelatin burned and the additional hydrated gelatin did not adhere to the substrate in a consistent manner. The amount of time required for the gelatin coating to dry was longer than that required for the unrefined collagen coating to dry. The results of this investigation demonstrate that gelatin is not suitable for use as a coating in accordance with the present invention.

### Example 3

436.4 g of gelatin was added to 187.0 g of water and mixed. Additional water was slowly added in measured quantities until all gelatin was hydrated. This required an additional 48 g of water to allow the gelatin to hydrate. The hydrated gelatin was then heated and rawhide sticks were coated in the heated gelatin. The melted gelatin exhibited a very high viscosity which made it very difficult to dip the rawhide.

Dipping the rawhide sticks into the gelatin did not produce a consistent coating and it was difficult to control the amount of coating that adhered to the rawhide. This was the result of the high viscosity of the melt. At this level of moisture, the melt was not pourable and had a globular gel consistency. The coating did not stay clear as air bubbles continued to become trapped within the gelatin making it murky-looking. As more air became entrapped, the temperature became much more difficult to maintain and never achieved over 200° F. even after one hour of simmering on medium heat. The coating had difficultly sticking to the rawhide, was uneven, and did not produce a hard coating.

### Example 4

The same materials were used as in Example 3, with an additional 70 g of water to achieve a pourable melt that was more conducive to dipping. Several sticks of rawhide were dipped into the melt and allowed to dry under ambient conditions.

The melt required temperatures of 160° F. to 170° F. to maintain low viscosity. The coating did not result in a hard coating and the rawhide softened quickly under the gelatin coating as moisture migrated into the rawhide. Additionally, air bubbles became entrapped in the gelatin coating producing a murky appearance to the coated chew.

### Example 5

PROBOND 1560 was melted in a heated vessel and several pieces of rawhide were dipped into this melt and allowed to dry under ambient conditions.

The melt was uniform and pourable. When the rawhide was dipped the melt produced a consistent coating on the rawhide that was appeared clear without very few air bubbles. Even at temperatures of about 140° F., the melt did not entrap air and was pourable. The rawhide sticks maintained their shape when coated and the coating produced after the coated rawhide had been dried was a very hard, clear coating.

### Example 6

Three tests using different amounts of glycerin were performed:
Test #1: 402 g of PROBOND 1560 (International Protein Colloids, Inc. Ft. Worth, Tex.) was mixed with 4.1 g of glycerin (1% by weight of the coating) and melted in a heated vessel.
Test #2: 405 g of PROBOND 1560 was mixed with 8.3 g of glycerin (2% by weight of the coating) and melted in a heated vessel.
Test #3: 406 g of PROBOND 1560 was mixed with 12.52 g of glycerin (3% by weight of the coating) and melted in a heated vessel.

Ten 5′ (inch) rawhide sticks were dipped in each of the collagen/glycerin mixtures and allowed to try at ambient temperature.

Visually the coated rawhide looked the same as when the PROBOND 1560 was used alone. The rawhide sticks maintained their shape when coated. It was additionally noticed that the chews coated in PROBOND 1560 and glycerin tended not to show signs of cracking when dried and exposed to dry air (air less than 50% relative humidity).

### Example 7

This example illustrates the extended length of chew time that was shown by the coated pet chew according to the present invention.

Several domestic dogs were given both a coated and uncoated rawhide to see how long it takes the dog to consume the rawhide. Dogs were given an uncoated rawhide stick on Day 1 and the length of time it took for the dogs to consume the chew was recorded. On Day 2, at the same time of day as on Day 1, the dog were given a coated rawhide, as described in Example 1, and the length it took for the dog to consume the treat was recorded. Observations, such as the dog's behavior when presented with the chew, overall attitude towards the chew by dog and pet owner, cleanliness of the chew when consumed, etc., was also documented.

The results may show that the coated pet chew takes longer for the dog to consume than an uncoated chew.

While the invention has been explained in relation to exemplary embodiments, it is to be understood that various modifications thereof will become apparent to those skilled in the art upon reading the description. Therefore, it is to be understood that the invention disclosed herein is intended to cover such modifications as fall within the scope of the appended claims.

1. A method of making a coated pet chew comprising the steps of:
(a) melting an amount of unrefined collagen to a temperature of about 100° F. to about 140° F. in a heated vessel,
(b) dipping a substrate suitable for chewing by a pet in a coating comprising the unrefined collagen such that the substrate is coated, and
(c) drying the coated substrate for 6 to 12 hours to produce a hard coating on the substrate thereby forming the coated pet chew.

2. The method of claim 1, wherein the coating additionally comprises glycerin.

3. The method of claim 1, wherein the glycerin is present in an amount of about 1% to about 5% by weight of the coating.

4. The method of claim 1, wherein the substrate is coated in a single coating.

5. The method of claim 4, wherein the single coating has a thickness of between about 0.1 mm and 0.8 mm.

6. The method of claim 4, wherein the substrate is coated in a double coating.

7. The method of claim 6, wherein the double coating has a thickness of between about 0.75 mm and 2.5 mm.

8. The method of claim 1, wherein the substrate is coated in a triple coating.

9. The method of claim 1, wherein the substrate is coated with four coatings.

10. The method of claim 1, wherein the coating additionally comprises a nutraceutical.

11. The method of claim 10, wherein a nutraceutical is included in the coating and is selected from the group consisting of D-Biotin, stabilized flax seed oil, Vitamin E, Vitamin B, Vitamin B6, Vitamin A, Vitamin D, polyunsaturated fatty acids, Panthothenic Acid, and combinations thereof.

12. The coated pet chew of claim 10, wherein the nutraceutical is present at a concentration of about 0.005% to about 2.0% by weight of the coating.

13. The method of claim 1, wherein the coating additionally comprises a colorant.

14. The method of claim 1, wherein the substrate is a rawhide.

15. The method of claim 1, wherein the coating is selected from the group consisting of a transparent clear coating, a transparent colored coating, and an opaque colored coating.
